(19) United States
(12) Patent Application Publication
(10) Pub. No.: US 2002/0057385 A1
(43) Pub. Date: May 16, 2002

(54) Data processing for fast transmission of webpages

(76) Inventors: Mingui Sun, Pittsburgh, PA (US); Qiang Liu, Pittsburgh, PA (US); Robert J. Sclabassi, Pittsburgh, PA (US)

Correspondence Address: Edward L. Pencoske, Esq., Thorp Reed & Armstrong, LLP, One Oxford Centre, 14th Floor, 301 Grant St., Pittsburgh, PA, 15219-1425, US

(21) Appl. No.: 09/904,791

(22) Filed: Jul. 13, 2001

Related U.S. Application Data
(60) Provisional application No. 60/218,930, filed on Jul. 14, 2000.

(51) Int. Cl. G06K 9/36

(52) U.S. Cl. 348/739

(57) ABSTRACT

The present invention is a method directed to selectively send non-textual information through a network that best adapts to the capacity of the receiving device, such as a display monitor on a remote computer. The method is comprised of steps of uploading the size of the remote display window and calculating the size of each image on the remote monitor. Wavelet coefficients of 1D, 2D or 3D images are produced and selectively transmitted to the monitor, with the most informative information transmitted first. The remote computer renders an image on the monitor based on the received coefficients. When the user increases the image size, additional coefficients are transmitted, and the resolution of the image is improved. The transmission stops when the display resolution of the remote monitor is met.

This application claims the benefit of U.S. Provisional application Ser. No. 60/218,930 filed Jul. 14, 2000.

### STATEMENT REGARDING FEDERALLY SPONSORED RESEARCH

This invention was made with government support under NIH Contract No. NS/MH38494-01. The government may have certain rights in this invention.

### BACKGROUND OF THE INVENTION

1. Field of the Invention

The present invention is directed generally to the transmission of data and, more specifically, to the transmission of data over a network, such as the Internet.

2. Description of the Background

This invention specifically attacks a significant problem in Internet transmission of data in the forms of image, music, voice, video sequence, etc. which are parts of a webpage. These data certainly enhance both the appearance and function of webpages; however, they take much longer to transmit than the textual information. The current approach to transmission attempts to display every fine detail in the webpage at the remote site, regardless of the viewer's interest. That is, the viewer may never pay attention to the fine details. As the traffic jam on the Internet increases, some frustrated surfers have nicknamed the “world wide web” (WWW) as the “world wide wait.”

### SUMMARY OF THE INVENTION

It is important to realize that the solution to this webpage loading problem is not only by increasing the speed of transmission, but also by improving the efficiency of transmission. Our invention adopts the second approach. Instead of sending all of the non-textual data contained in a webpage, we selectively send the information that best adapts to the capacity of the receiving device, e.g., the dimensions of a display window on a remote monitor for the page of interest. Our invention applies a novel application of advanced digital signal processing techniques, including the integer-to-integer wavelet transform and the set partition in hierarchical tree (SPIHT) coding algorithm, to the webpage loading problem. Our experiments indicate that, under a fixed loading speed, this invention greatly reduces the waiting time spent for information to be transmitted across the network.

### BRIEF DESCRIPTION OF THE DRAWINGS

For the present invention to be readily understood and practiced, the present invention will now be described, for purposes of illustration and not limitation, in conjunction with the following figures wherein:

FIG. 1 illustrates a system with which the present invention may be used;

FIG. 2 is a block diagram illustrating the method of the present invention; and

FIGS. 3A-3E illustrate sample data.

### DETAILED DESCRIPTION OF THE PREFERRED EMBODIMENTS

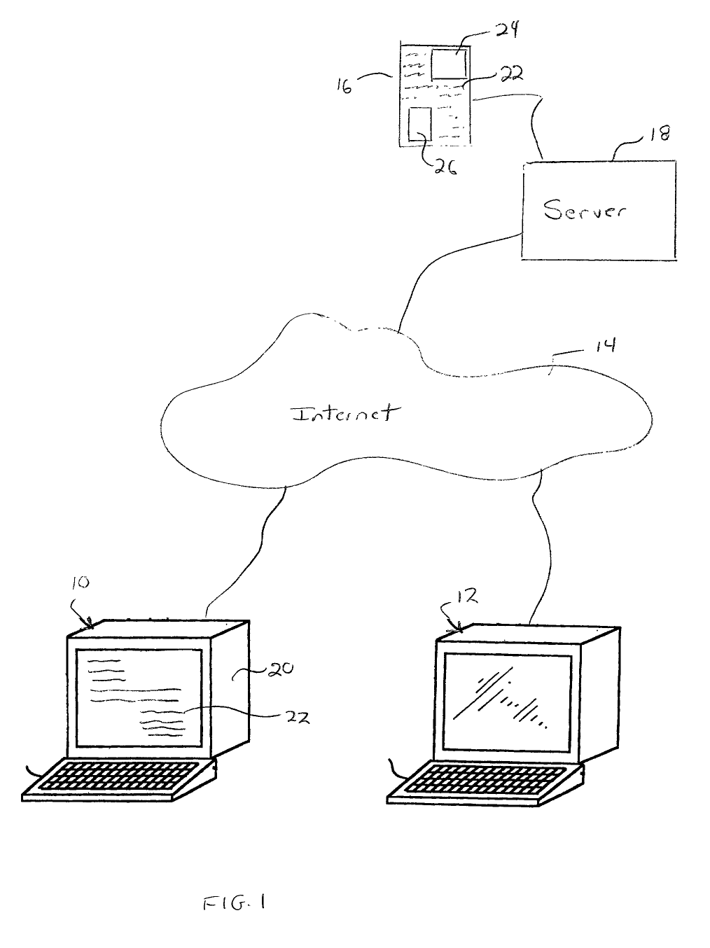

The present invention may be utilized, for example, for transmitting information over the Internet although the reader should recognize that other types of communication networks may be used in place of the Internet. Also, the invention is described in terms of transmitting an image although other types of non-textual data may be transmitted in place of the image. Where data other than images is being transmitted, the parameter(s) of interest at the remote device are those related to the output device that is to reproduce the data, e.g., an audio device. In FIG. 1, a first user computer 10 and a second user computer 12 are shown in communication with the Internet 14. Assume that the first user computer 10 has identified information in the form of webpage 16 on a server 18 which the first user wishes to access.

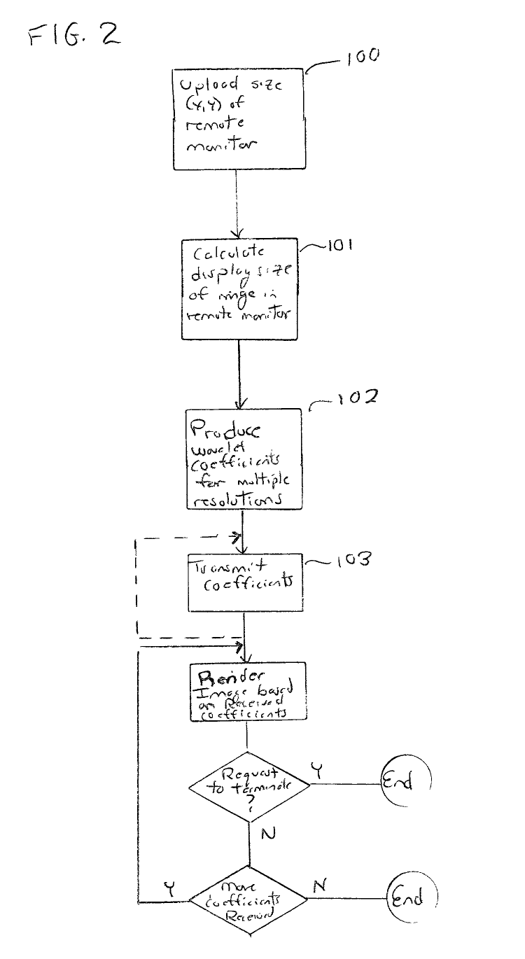

In our approach, text 22, which is relatively small in size, is transmitted first and rendered immediately on remote monitor 20. However, images 24, 26 in webpage 16 are not directly transmitted. Instead, they are pre-processed by server 18 according to the following steps (see FIG. 2): In step 100, a pair of integers, (X, Y), specifying the numbers of horizontal and vertical pixels of the window that displays the webpage on the remote monitor, is uploaded to server 18. In step 101, based on that pair, the actual display size, (xi, yi), of each image 24, 26 in the display window can be calculated by server 18. In step 102, the integer-to-integer wavelet transform [1] is computed for each image 24, 26 producing wavelet coefficients for multiple resolutions. “Second generation wavelets” are utilized which down-sample the images 24, 26 in the webpage 16 to adapt to the (xi, yi) pairs if the sizes of images provided in the webpage 16 are larger than the capacity of remote monitor 20. In step 103, the SPIHT compression algorithm [2] is utilized to transmit the wavelet coefficients in a bit-plane fashion. In step 104, at the user computer 10 these coefficients are processed by the inverse lifting scheme, which produces low-resolution images to be displayed on the monitor 20. With the arrival of more wavelet coefficients having increasing numbers of effective bits, the images on the remote monitor 20 are progressively updated and re-rendered until all necessary information is transmitted. A distinct advantage of this method is that this form of data transmission can be terminated abruptly, either upon requested by the user or due to an unexpected stalling of the network because, in this case, an intact webpage is reconstructible on the remote monitor 20 with a reduced image resolution, after the first batch of wavelet coefficients has been sent.

Note that in the case of transmitting waveforms, such as biomedical signals, the same algorithm is utilized except that the wavelet transform becomes one-dimensional. For music and voices, the (xi, yi) parameter pair is replaced by a single quality control parameter according to the installed audio device, or provided by the user according to his/her preference. Only the wavelet coefficients that comply with the minimum quality requirement are transmitted. In case of network congestion, the transmitted music or voice will contain data segments of shorter bandwidth, as opposed to the currently experienced unpleasant delays and gaps.

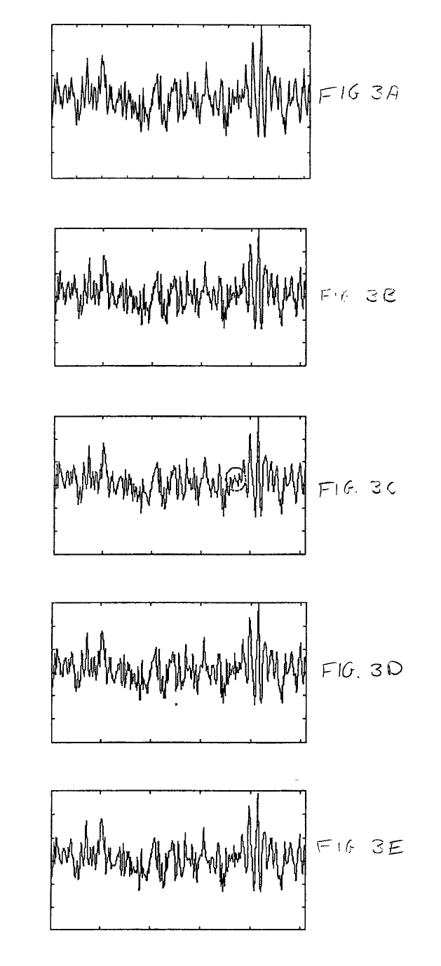

We obtained test data by remotely displaying a segment of electroencephalogram (EEG). In terms of computational assessment, this case is similar to displaying an image, but the dimensionality in the wavelet transform is reduced. We assumed that 256 pixels are available (length-wise) on a seventeen inch remote monitor, and that the actual data contained in the webpage has 512 sample points. Thus, the number of points to be displayed is twice the number of pixels in the display window length. This resolution mismatch is common in practice because the average home computer does not usually have the high resolution provided by the webpage, and the Internet browser window does not always occupy the entire display screen. FIG. 3A shows the “true” signal plotted using a 600 dpi laser printer which simulates the display in unlimited resolution. FIG. 3B shows the same segment actually displayed on the computer screen. It is clear that, when the entire dataset of 512 samples is transmitted, the monitor is incapable of rendering this dataset. Hence, it is wasteful to transmit, as we currently do, the data which are nevertheless redundant. An obvious solution is to down-sample the data (by two in this case) before transmission (see FIG. 3C); however, significant distortion results (see the circled area where large peaks in the original waveform are lost).

We computed the integer-to-integer wavelet transform of the data using the lifting scheme and transmitted the data according the amplitude values of the wavelet coefficient. A small number of larger coefficients was transmitted first to reconstruct the initial low-resolution waveform which was immediately displayed on the remote monitor while the transmission was in progress. As more wavelet coefficients arrived, the display was updated repeatedly. FIGS. 3D and 3E, respectively, show the results of display after 33% and 50% of the data were transmitted. Our independent observers judged that, when compared to FIG. 3A, FIG. 3D was more faithful than FIG. 3B, although the transmission speed of FIG. 3D was three times faster.

Transmission of webpage images in increasing resolutions has been reported in the literature. However, the reported approaches neither adapt to the size of the remote display window, nor utilize the powerful combination of the second generation wavelet transform and the modified SPIHT algorithm. The performances of the existing approaches are considerably inferior.

The information transmitted may be various forms of non-textual data, including one-dimensional time series (e.g. music, voice, or a trace of data), two-dimensional time series (e.g., a video sequence), two-dimensional still images (e.g., an image of merchandise), or three-dimensional still images. By our invention all these data forms can be minimally transmitted according to the uploaded control parameters reflecting the capacity of the receiving devices. In the case of 3-D images, the raw data is stored in the host computer as wavelet coefficients in indexed, multiple resolutions. When the user selects a perspective, the perspective parameters and the display window size are both uploaded to the host computer, and only the minimum number of wavelet coefficients generated for the particular perspective are transmitted through the Internet.

A parser may be used to determine the importance of the coefficients followed by selection of the most important coefficients for transmission. The number of most important coefficients is determined by, for example, the resolution of the remote display. The coefficients are capable of adapting to arbitrary remote window dimensions. Additionally, the remote window dimensions may change as, for example, when the user drags the display window to increase the image size. In the event coefficients have already been transmitted, the parser would select additional coefficients from the remaining coefficients for transmission. The indices of the coefficients which are transmitted may be recorded on both the host and client sites in the coder and decoder.

Some unique advantages of this invention are: 1) by uploading several display parameters to the host computer, only the effective portion of the data for webpage display is transmitted. This approach saves considerable transmission time. 2) The effective data are decomposed into certain priorities, the most essential data are transmitted first. 3) Images in the webpage are displayed immediately in low-resolution once the data of the highest priority, which represents a small percentage of the complete dataset, is received. This allows the user to make a decision whether to wait for more detailed display or depart for a new webpage. By the same token, network stalling after the first round of data transmission will not be as destructive as in the current transmission mode, because the entire webpage is already displayed. 4) Webpage writers can put large-size images, or even 3-D images, which can be viewed in different perspectives, into their webpages without affecting the transmission speed (remember that the maximum image dimensions actually transmitted depend on the display area for this image on the remote monitor). This provides an unprecedented opportunity allowing the viewer to re-scale or zoom-in on any image of his/her interest repeatedly to observe the details of the object. We believe that this unique feature is highly attractive to various web-commerces, web-entertainments, real estate, and other industries, as well as billions of web users. Thus, this invention could have a strong impact on facilitating the information super highway.

The following references are incorporated by reference:

[1] Wim Sweldens, “The Lifting Scheme: A New Philosophy in Biorthogonal Wavelet constructions”, Wavelet Applications in Signal and Image Processing III, A.F. Laine and M. Unser, ed., Proc. SPIE 2569, 1995, pp. 68-79.

[2] A. Said and W. A. Pearlman, “A new, fast, and efficient inage codec based on set partitioning in hierarchical trees,” IEEE Trans. Circuits and Syst. for Video Tech., vol. 6, 1996, pp. 243-250.

While the present invention has been described in conjunction with preferred embodiments, those of ordinary skill in the art will recognize that many modifications and variations are possible. The foregoing description and following claims are intended to cover such modifications and variations.

What is claimed is:

1. A method of transmitting non-textual data, comprising:
uploading the size of a remote monitor to a host;
calculating a display size for the non-textual data on the remote monitor;
producing information capable of rendering the non-textual data at a plurality of resolutions for the calculated size;
transmitting the information;
rendering the non-textual data at a resolution based on the amount of received information.

2. The method of claim 1 wherein the information includes wavelet coefficients.

3. A method of transmitting a data sequence over a network, comprising:
uploading the parameters of a remote output device to a host;
selecting wavelet coefficients of the data sequence for transmission according to the uploaded parameters; and
progressively transmitting coefficients until the parameters of the output device are met.

4. The method of claim 3 additionally comprising the step of transmitting additional coefficients when the size of the remote window is increased.

5. The method of claim 3 wherein the data sequence includes one of a one-dimensional, two-dimensional and three-dimensional images, music, speech, and video sequences.

6. The method of claim 5 wherein the data sequence includes a three-dimensional image, said method additionally comprising the step of decomposing the three-dimensional image into a plurality of wavelet coefficients of two-dimensional perspectives.

7. The method of claim 3 additionally comprising the steps of examining the importance of coefficients and selecting for transmission the most important coefficients based on the resolution of the remote window.

8. The method of claim 3 wherein the coefficients are capable of adapting to arbitrary remote window dimensions.

9. The method of claim 3 additionally comprising the step of progressively receiving the transmitted coefficients and reconstructing the data sequence.

10. The method of claim 9 additionally comprising the step of recording the indices of the coefficients.

11. The method of claim 10 wherein said step of recording includes the step of recording at both the host and remote sites.
